(19) United States
(12) Patent Application Publication
(10) Pub. No.: US 2026/0213174 A1
(43) Pub. Date: Jul. 23, 2026

(54) POSITIVE ELECTRODE ACTIVE MATERIAL FOR SODIUM-ION BATTERIES, METHOD FOR MANUFACTURING SAME, AND SODIUM-ION BATTERY

(71) Applicants: Toyota Jidosha Kabushiki Kaisha, Toyota-shi (JP); National University Corporation Hokkaido University, Sapporo-shi (JP)

(72) Inventors: Hiroko KUWATA, Sunto-gun (JP); Hiroaki KOBAYASHI, Sapporo-shi (JP)

(73) Assignees: Toyota Jidosha Kabushiki Kaisha, Toyota-shi (JP); National University Corporation Hokkaido University, Sapporo-shi (JP)

(21) Appl. No.: 19/449,855

(22) Filed: Jan. 15, 2026

(30) Foreign Application Priority Data
Jan. 20, 2025 (JP) 2025-007764

(51) Int. Cl. H01M 4/485; C01G 49/00; H01M 10/054

(52) U.S. Cl. CPC H01M 4/485; C01G 49/0027; C01G 49/0072; H01M 10/054; C01P 2002/76; C01P 2006/40

(57) ABSTRACT

Disclosed is a positive electrode active material for sodium-ion batteries that has high capacity. The positive electrode active material for sodium-ion batteries of the present disclosure comprises a Na-containing composite oxide having a chemical composition represented by NaₓFe_{y}M_{1-y}O_{z} (wherein 3.0<x<9.0, 0<y≤1.0, 3.0<z<6.0, and M: one or more selected from Mn, P, Cr, Sc, Ti, V, Cr, Co, Ni, Cu, Zn, and Ga) and having a crystal structure belonging to space group Pn21a.

### FIELD

The present application discloses a positive electrode active material for sodium-ion batteries, a method for manufacturing the same, and a sodium-ion battery.

### BACKGROUND

There has been a demand for high-performance positive electrode active materials for sodium-ion batteries that consist of rare metal-free materials. PTL 1 discloses a positive electrode active material for sodium secondary batteries represented by general formula Na₅Mn₍₁₋ₓ₎FeₓO₄(0<x≤0.2). PTL 2 discloses a sodium-containing composite oxide having a predetermined chemical composition as a precursor for a positive electrode active material for lithium-ion batteries.

### CITATION LIST

### Patent Literature

[PTL 1] Japanese Unexamined Patent Publication (Kokai) No. 2014-164860
[PTL 2] Japanese Unexamined Patent Publication (Kokai) No. 2009-184844

### SUMMARY

### Technical Problem

Conventional positive electrode active materials for sodium-ion batteries have room for improvement in terms of capacity.

### Solution to Problem

The present application, as a means for achieving the object above, discloses the following plurality of aspects.

### Aspect 1

A positive electrode active material for sodium-ion batteries, comprising a Na-containing composite oxide, wherein
the Na-containing composite oxide has a chemical composition represented by

$${Na}_{x} {Fe}_{y} {M}_{1 - y} {O}_{z}$$

$$3. < x < 9. ;$$

$$0 < y \leq 1. ;$$

$$3. < z < 6. ;$$

and
M: one or more selected from Mn, P, Cr, Sc, Ti, V, Cr, Co, Ni, Cu, Zn, and Ga, and the Na-containing composite oxide has a crystal structure belonging to space group Pn21a.

### Aspect 2

The positive electrode active material for sodium-ion batteries according to Aspect 1, wherein
the Na-containing composite oxide has a chemical composition represented by

$${Na}_{x} {Fe}_{y} {M}_{1 - y} {O}_{z}$$

$$3. < x < 6. ;$$

$$0.5 < y \leq 1. ; and$$

$$3. < z < 4.5 .$$

### Aspect 3

A method for manufacturing a positive electrode active material for sodium-ion batteries, the method comprising
obtaining a mixture comprising a Na-containing oxide and a Fe-containing oxide, and
applying an energy to the mixture to obtain a Na-containing composite oxide, wherein
   a ratio of the Na-containing oxide to the Fe-containing oxide in the mixture is adjusted so that the Na-containing composite oxide has a chemical composition represented by

$${Na}_{x} {Fe}_{y} {M}_{1 - y} {O}_{z}$$

$$3. < x < 9. ;$$

$$0 < y \leq 1. ;$$

$$3. < z < 6. ;$$

and
M: one or more selected from Mn, P, Cr, Sc, Ti, V, Cr, Co, Ni, Cu, Zn, and Ga, and
the energy applied to the mixture is adjusted so that the Na-containing composite oxide has a crystal structure belonging to space group Pn21a.

### Aspect 4

The method for manufacturing a positive electrode active material for sodium-ion batteries according to Aspect 3, the method comprising
applying mechanical energy to the mixture by mechanical milling to obtain the Na-containing composite oxide, wherein
firing of the Na-containing composite oxide is not carried out after the mechanical milling.

### Aspect 5

A sodium-ion battery, comprising a positive electrode active material layer, an electrolyte layer, and a negative electrode active material layer, wherein
the positive electrode active material layer comprises the positive electrode active material for sodium-ion batteries according to Aspect 1 or 2.

### Effects

The positive electrode active material for sodium-ion batteries of the present disclosure has high capacity.

### BRIEF DESCRIPTION OF DRAWINGS

FIG. 1 shows one example of a method for manufacturing a positive electrode active material for sodium-ion batteries.

FIG. 2 schematically shows one example of a configuration of a sodium-ion battery.

### DESCRIPTION OF EMBODIMENTS

Hereinafter, one embodiment of each of the positive electrode active material for sodium-ion batteries, the method for manufacturing the same, and the sodium-ion battery of the present disclosure will be described. However, the positive electrode active material for sodium-ion batteries, the method for manufacturing the same, and the sodium-ion battery of the present disclosure are not limited to the embodiment described below.

### 1. Positive Electrode Active Material for Sodium-Ion Batteries

The positive electrode active material for sodium-ion batteries according to the embodiments comprises a Na-containing composite oxide. The Na-containing composite oxide has the chemical composition indicated below. The Na-containing composite oxide has a crystal structure belonging to space group Pn21a.

$${Na}_{x} {Fe}_{y} {M}_{1 - y} {O}_{z}$$

$$3. < x < 9.$$

$$0 < y \leq 1.$$

$$3. < z < 6.$$

M: one or more selected from Mn, P, Cr, Sc, Ti, V, Cr, Co, Ni, Cu, Zn, and Ga

### 1.1 Chemical Composition

In the present embodiment, the Na-containing composite oxide has a chemical composition represented by NaₓFe_{y}M_{1-y}O_{z}. M is one or more selected from Mn, P, Cr, Sc, Ti, V, Cr, Co, Ni, Cu, Zn, and Ga. Particularly, when Mis Mn, higher capacity is easily ensured.

In the present embodiment, x is greater than 3.0 and less than 9.0, and may be 3.5 or greater, 4.0 or greater, or 4.5 or greater, and may be 8.5 or less, 8.0 or less, 7.5 or less, 7.0 or less, 6.5 or less, 6.0 or less, less than 6.0, or 5.5 or less. Particularly, when x is greater than 3.0 and less than 6.0, higher capacity is easily ensured.

In the present embodiment, y is greater than 0 and 1.0 or less, and may be 0.1 or greater, 0.2 or greater, 0.3 or greater, 0.4 or greater, 0.5 or greater, greater than 0.5, 0.6 or greater, 0.7 or greater, 0.8 or greater, or 0.9 or greater. In the present embodiment, when the transition metal contained in the Na-containing composite oxide is mainly Fe, high capacity is ensured as a positive electrode active material for sodium-ion batteries. Specifically, the above y may be greater than 0.5 and 1.0 or less.

In the present embodiment, z is greater than 3.0 and less than 6.0, and may be 3.3 or greater, 3.5 or greater, or 3.7 or greater, and may be 5.7 or less, 5.5 or less, 5.3 or less, 5.0 or less, 4.7 or less, 4.5 or less, less than 4.5, or 4.3 or less.

In the present embodiment, the transition metal contained in the Na-containing composite oxide is mainly Fe, and may optionally comprise Mn. For example, in one embodiment, the Na-containing composite oxide may have the chemical composition indicated below.

$${Na}_{x} {Fe}_{y} {M}_{1 - y} {O}_{z}$$

$$3. < x < 6.$$

$$0.5 < y \leq 1.$$

$$3. < z < 4.5$$

### 1.2 Crystal Structure

In the present embodiment, the Na-containing composite oxide has a crystal structure belonging to the space group Pn21a. The Na-containing composite oxide has specific chemical composition and crystal structure, whereby high capacity is obtained. The sodium-containing composite oxide may have a crystal structure belonging to the space group Pn21a and another crystal structure. Alternatively, the sodium-containing composite oxide may have only a crystal structure belonging to the space group Pn21a (only diffraction peaks originating from crystal structure belonging to the space group Pn21a are observed in the X-ray diffraction pattern). For example, in the X-ray diffraction pattern obtained when the sodium-containing composite oxide is subjected to X-ray diffraction measurement using synchrotron radiation having a wavelength of 0.0775 nm, at least two peaks, a first peak and a second peak, may be observed. The first peak may be present at q=0.23±0.02 angstrom⁻¹, and the second peak may be present at q=−1 0.38±0.02 angstrom

### 1.3 Others

As described above, the positive electrode active material for sodium-ion batteries according to the embodiments comprises a Na-containing composite oxide having the above specific chemical composition and crystal structure, whereby high capacity is obtained. The positive electrode active material according to one embodiment may consist only of the above Na-containing composite oxide, or may comprise the above Na-containing composite oxide and another component (additional component). From the viewpoint of further increasing the above effect, the proportion of the additional component in the entire positive electrode active material may be a small amount. For example, when the entirety of the positive electrode active material is 100% by mass, the content of the above Na-containing composite oxide may be 50% by mass or more and 100% by mass or less, 60% by mass or more and 100% by mass or less, 70% by mass or more and 100% by mass or less, 80% by mass or more and 100% by mass or less, 90% by mass or more and 100% by mass or less, 95% by mass or more and 100% by mass or less, or 99% by mass or more and 100% by mass or less.

The positive electrode active material for sodium-ion batteries according to the embodiments may be a solid particle, may be a hollow particle, or may be a particle having a void. The size of the positive electrode active material is not particularly limited. For example, the average particle size of the positive electrode active material may be 0.1 μm or more and 10 μm or less, 1.0 μm or more and 8.0 μm or less, or 2.0 μm or more and 6.0 μm or less. The average particle size referred to in the present application is the particle size at 50% of the cumulative value of particle size distribution based on volume (D50, median diameter) measured by a laser diffraction/scattering method.

### 2. Method for Manufacturing Positive Electrode Active Material for Sodium-Ion Batteries

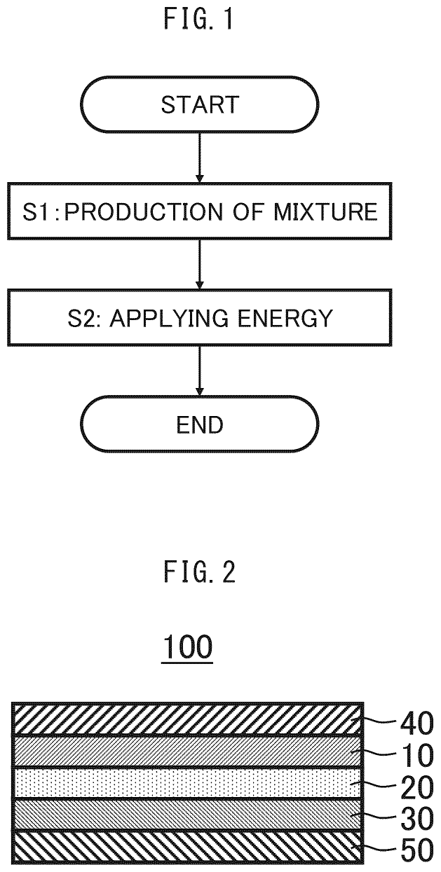

The Na-containing composite oxide having the above chemical composition and crystal structure can be manufactured, for example, by the following method. As shown in FIG. 1, the method for manufacturing the positive electrode active material for sodium-ion batteries according to one embodiment comprises

S1: obtaining a mixture comprising a Na-containing oxide and a Fe-containing oxide, and

S2: applying an energy to the mixture to obtain a Na-containing composite oxide.

In the present embodiment, the ratio of the Na-containing oxide to the Fe-containing oxide in the mixture is adjusted so that the Na-containing composite oxide has the chemical composition indicated below, and the energy applied to the mixture is adjusted so that the Na-containing composite oxide has a crystal structure belonging to space group Pn21a.

$${Na}_{x} {Fe}_{y} {M}_{1 - y} {O}_{z}$$

$$3. < x < 9.$$

$$0 < y \leq 1.$$

$$3. < z < 6.$$

M: one or more selected from Mn, P, Cr, Sc, Ti, V, Cr, Co, Ni, Cu, Zn, and Ga

### 2.1 S1: Production of Mixture

In S1, a Na-containing oxide and a Fe-containing oxide are mixed so as to obtain the above predetermined ratio, whereby a mixture is obtained.

The Na-containing oxide constituting the mixture, for example, may be sodium oxide (Na₂O). Alternatively, the Na-containing oxide constituting the mixture may comprise a composite oxide of Na and M. For example, the Na-containing oxide constituting the mixture may comprise NaMnO₂. In the present embodiment, for example, sodium oxide (Na₂O) may be adopted as the Na-containing oxide, and the proportion of the sodium oxide (Na₂O) in the mixture may be adjusted so that in the Na-containing composite oxide obtained after S2, x is greater than 3.0 and less than 9.0, y is greater than 0 and 1.0 or less, and z is greater than 3.0 and less than 6.0.

The Fe-containing oxide constituting the mixture, for example, may be iron oxide (Fe₂O₃). Alternatively, the Fe-containing oxide constituting the mixture may be a composite oxide of Na and Fe. For example, the Fe-containing oxide constituting the mixture may be NaFeO₂. In the present embodiment, for example, NaFeO₂ may be adopted as the Fe-containing oxide, and the proportion of NaFeO₂ in the mixture may be adjusted so that in the Na-containing composite oxide obtained after S2, x is greater than 3.0 and less than 9.0, y is greater than 0 and 1.0 or less, and z is greater than 3.0 and less than 6.0.

The mixture may comprise a M-containing oxide in addition to the Na-containing oxide and the Fe-containing oxide. The M-containing oxide, for example, may be an oxide consisting only of M and O, such as manganese oxide (Mn₂O₃). Alternatively, when sodium oxide (Na₂O) is adopted as the Na-containing oxide, the M-containing oxide may be a composite oxide of Na and M. For example, the M-containing oxide constituting the mixture may be NaMnO₂. In the present embodiment, for example, NaMnO₂ may be adopted as the M-containing oxide, and the proportion of NaMnO₂ in the mixture may be adjusted so that in the Na-containing composite oxide obtained after S2, x is greater than 3.0 and less than 9.0, y is greater than 0 and 1.0 or less, and z is greater than 3.0 and less than 6.0.

The mixing ratio of the Na-containing oxide to the Fe-containing oxide needs only to be adjusted so that the Na-containing composite oxide obtained after S2 has the chemical composition described above. The values that can be assumed by x, y, and z in the chemical composition are as described above, and thus the descriptions thereof will be omitted.

Each of the crystal structures of the Na-containing oxide, Fe-containing oxide, and M-containing oxide constituting the mixture is not particularly limited. In the present embodiment, an energy is applied to the mixture in S2 described below, whereby a Na-containing composite oxide having a crystal structure belonging to the space group Pn21a is ultimately obtained. Specifically, prior to S2, each of the crystal structures of the Na-containing oxide, Fe-containing oxide, and M-containing oxide constituting the mixture may belong to a space group different from the space group Pn21a.

### 2.2 S2: Energy Application

In S2, an energy is applied to the mixture obtained via S1, whereby a Na-containing composite oxide having a crystal structure belonging to the space group Pn21a is obtained.

The method of applying an energy to the mixture is not particularly limited as long as the above predetermined crystal structure can be obtained. In one embodiment, the mixture may be subjected to firing. When the mixture is subjected to firing, the firing temperature, firing time, and firing atmosphere are not particularly limited as long as the above specific crystal structure can be obtained. For example, the firing temperature may be 500° C. or higher and 700° C. or lower, the firing time may be 10 h or more and 48 h or less, and the firing atmosphere may be an oxygen-containing atmosphere or an inert gas atmosphere. Alternatively, in one embodiment, the mixture may be subjected to mechanical milling. When the mixture is subjected to mechanical milling, the rotation speed, rotation time, and number of repetitions of mechanical milling are not particularly limited as long as the above specific crystal structure can be obtained. One example of conditions of mechanical milling is as indicated in the Examples described below.

According to new findings by the present inventors, it is preferable that crystallinity of the Na-containing composite oxide obtained after S2 be moderately low, which is likely to further increase the capacity of the positive electrode active material. For example, it is preferable that the manufacturing method according to the present embodiment comprise applying mechanical energy to the mixture by mechanical milling to obtain the Na-containing composite oxide, and that firing of the Na-containing composite oxide not be carried out after the mechanical milling. By subjecting the mixture to mechanical milling and omitting a subsequent firing, the mixture can be moderately crystallized, the ultimately obtained Na-containing composite oxide has a crystal structure belonging to the space group Pn21a, and atomic arrangement in the crystal structure can be moderately randomized, which is considered to allow Na ions to move easily in the crystal structure. It is considered that due to mechanical milling, conductivity in the Na-containing composite oxide can be increased, enabling utilization of redox reactions of both Fe and O. Specifically, it is considered that by using the Na-containing composite oxide after mechanical milling directly as a positive electrode active material without firing, higher capacity can be obtained.

### 3. Sodium-Ion Battery

FIG. 2 schematically shows a configuration of the sodium-ion battery according to one embodiment. As shown in FIG. 2, the sodium-ion battery 100 according to one embodiment comprises a positive electrode active material layer 10, an electrolyte layer 20, and a negative electrode active material layer 30. The positive electrode active material layer 10 comprises the positive electrode active material for sodium-ion batteries according to the above embodiment.

### 3.1 Positive Electrode Active Material Layer

The positive electrode active material layer 10 comprises at least the positive electrode active material according to the above embodiment, and may further optionally comprise an electrolyte, a conductive aid, and a binder. Further, the positive electrode active material layer 10 may additionally comprise various additives. The contents of the active material, electrolyte, conductive aid, and binder in the positive electrode active material layer 10 need only to be appropriately determined in accordance with target battery performance. For example, when the entirety (entire solid content) of the positive electrode active material layer 10 is 100% by mass, the content of the active material may be 40% by mass or more, 50% by mass or more, or 60% by mass or more, and may be 100% by mass or less or 90% by mass or less. The shape of the positive electrode active material layer 10 is not particularly limited, and for example, may be a sheet-like positive electrode active material layer 10 having a substantially flat surface. The thickness of the positive electrode active material layer 10 is not particularly limited, and for example, may be 0.1 μm or more or 1 μm or more, and may be 2 mm or less or 1 mm or less.

The electrolyte that can be contained in the positive electrode active material layer 10 may be a solid electrolyte, may be a liquid electrolyte (electrolytic solution), or may be a combination thereof. The solid electrolyte may be any solid electrolyte as long as a known one is used. The solid electrolyte may be an inorganic solid electrolyte, or may be an organic polymer electrolyte. Particularly, an inorganic solid electrolyte has excellent ion-conducting properties and heat resistance. Examples of the inorganic solid electrolyte include at least one selected from oxides such as Na₃Zr₂PSi₂O₁₂ and Na₂O-11Al₂O₃; hydrides and borides such as NaBH₄, NaB₁₀H₁₀, NaCB₉H₁₀, NaCB₁₁H₁₂, and NaB₁₂Cl₁₂; sulfides such as Na₃PS₄, Na₃SbS₄, and Na_{2.88}Sb_{0.88} W_{0.12}S₄; and fluorides such as NaPF₆ and NaBF₄. The solid electrolyte, for example, may be particulate. The solid electrolyte may be of one type used alone, or may be of two or more types used in combination. The electrolytic solution, for example, comprises sodium ions as carrier ions. The electrolytic solution may be an aqueous electrolytic solution or a nonaqueous electrolytic solution. The composition of the electrolytic solution needs only to be the same as one known as a composition of an electrolytic solution for batteries. For example, a sodium salt dissolved at a predetermined concentration in a carbonate-based solvent can be used as the electrolytic solution. Examples of the carbonate-based solvent include fluoroethylene carbonate (FEC), ethylene carbonate (EC), propylene carbonate (PC), diethyl carbonate (DEC), dimethyl carbonate (DMC), and ethyl methyl carbonate (EMC). Examples of the sodium salt include NaPF₆, NaClO₄, NaBF₄, NaFSI, NaTFSI, and NaBETI.

Examples of the conductive aid that can be contained in the positive electrode active material layer 10 include carbon materials such as vapor-grown carbon fiber (VGCF), acetylene black (AB), Ketjenblack (KB), carbon nanotube (CNT), and carbon nanofiber (CNF); and metal materials such as nickel, aluminum, and stainless steel. The conductive aid, for example, may be particulate or fibrous, and the size thereof is not particularly limited. The conductive aid may be of one type used alone, or may be of two or more types used in combination.

Examples of the binder that can be contained in the positive electrode active material layer 10 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. The binder may be of one type used alone, or may be of two or more types used in combination.

### 3.2 Electrolyte Layer

The electrolyte layer 20 comprises at least an electrolyte. When the sodium-ion battery 100 is a solid battery (may be a battery comprising a solid electrolyte with a liquid electrolyte partially used in combination, or may be an all-solid battery free of a liquid electrolyte), the electrolyte layer 20 comprises a solid electrolyte, and may further optionally comprise a binder. In this case, the contents of the solid electrolyte and the binder in the electrolyte layer 20 are not particularly limited. When the battery 100 is an electrolytic solution battery, the electrolyte layer 20 comprises an electrolytic solution, and may further comprise a separator for retaining the electrolytic solution and preventing contact between the positive electrode active material layer 10 and the negative electrode active material layer 30. The thickness of the electrolyte layer 20 is not particularly limited, and for example, may be 0.1 μm or more or 1 μm or more, and may be 2 mm or less or 1 mm or less.

The electrolyte contained in the electrolyte layer 20 needs only to be appropriately selected from among electrolytes exemplified as an electrolyte that can be contained in the positive electrode active material layer 10 described above. The binder that can be contained in the electrolyte layer 20 needs only to be appropriately selected from among binders exemplified as a binder that can be contained in the positive electrode active material layer 10 described above. The electrolyte and the binder may each be of one type used alone, or may be of two or more types used in combination. The separator needs only to be any separator normally used in batteries. Examples thereof include those made of resins such as polyethylene (PE), polypropylene (PP), polyester, and polyamide. The separator may be of a single-layer structure, or may be of a multilayer structure. Examples of separators having a multilayer structure can include separators of a PE/PP two-layer structure and separators of a PP/PE/PP or PE/PP/PE three-layer structure. The separator may consist of a nonwoven fabric such as cellulose nonwoven fabric, resin nonwoven fabric, or glass-fiber nonwoven fabric.

### 3.3 Negative Electrode Active Material Layer

The negative electrode active material layer 30 comprises at least a negative electrode active material, and may optionally comprise an electrolyte, a conductive aid, and a binder. Further, the negative electrode active material layer 30 may additionally comprise various additives. The content of each of the negative electrode active material, electrolyte, conductive aid, and binder in the negative electrode active material layer 30 needs only to be appropriately determined in accordance with target battery performance. For example, when the entirety (entire solid content) of the negative electrode active material layer 30 is 100% by mass, the content of the negative electrode active material may be 40% by mass or more, 50% by mass or more, or 60% by mass or more, and may be 100% by mass or less or 90% by mass or less. The shape of the negative electrode active material layer 30 is not particularly limited, and for example, may be a sheet-like negative electrode active material layer having a substantially flat surface. The thickness of the negative electrode active material layer 30 is not particularly limited, and for example, may be 0.1 μm or more or 1 μm or more, and may be 2 mm or less or 1 mm or less.

Various materials having low electric potentials (charge and discharge potentials) for storing and releasing charge-compensating ions compared to the above positive electrode active material can be adopted as the negative electrode active material. The negative electrode active material, for example, may be an inorganic-based negative electrode active material such as metallic sodium, may be a negative electrode active material consisting of an organic compound, or may be a combination thereof. The negative electrode active material may be of one type used alone, or may be of two or more types used in combination. The shape of the negative electrode active material needs only to be any of general shapes of negative electrode active materials of batteries. For example, the negative electrode active material may be particulate. The negative electrode active material particles may be primary particles, or may be secondary particles of a plurality of agglomerated primary particles. The average particle size (D50) of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a sodium foil. Specifically, the negative electrode active material layer 30 may consist of a sheet of a negative electrode active material.

Examples of the electrolyte that can be contained in the negative electrode active material layer 30 include the above solid electrolytes and electrolytic solutions, and combinations thereof. Examples of the conductive aid that can be contained in the negative electrode active material layer 30 include the above carbon materials and the above metal materials. The binder that can be contained in the negative electrode active material layer 30 needs only to be appropriately selected, for example, from among binders exemplified as a binder that can be contained in the above positive electrode active material layer 10. The electrolyte and the binder may each be of one type used alone, or may be of two or more types used in combination.

### 3.4 Additional Configurations

As shown in FIG. 2, the sodium-ion battery 100 may be provided with a positive electrode current collector 40 in contact with the above positive electrode active material layer 10. Any general positive electrode current collector for batteries can be adopted as the positive electrode current collector 40. As shown in FIG. 2, the sodium-ion battery 100 may be provided with a negative electrode current collector 50 in contact with the above negative electrode active material layer 30. Any general negative electrode current collector for batteries can be adopted as the negative electrode current collector 50. The sodium-ion battery 100, in addition to the above configuration, may be provided with any obvious configurations for a battery, such as tabs or terminals. The above configurations of the sodium-ion battery 100 may each be housed inside an outer packaging. Any known outer packaging can be adopted as the outer packaging of the battery. In addition, a plurality of sodium-ion batteries 100 may be optionally connected electrically and optionally stacked to form a battery pack. In this case, the battery pack may be housed inside a known battery case. Examples of shapes of the sodium-ion battery 100 can include coin type, laminate type, cylindrical type, and square type. The sodium-ion battery 100 may be a secondary battery.

### 4. Method for Manufacturing Battery

The sodium-ion battery 100 can be manufactured by applying any known method, except that the above specific positive electrode active material be used, and for example, can be manufactured as follows. However, the manufacturing method for the sodium-ion battery 100 is not limited to the following method. For example, each layer may be formed by dry molding.

(1) A positive electrode active material constituting a positive electrode active material layer is dispersed in a solvent to obtain a positive electrode layer slurry. The solvent used in this case is not particularly limited, and water and various organic solvents can be used. The positive electrode layer slurry is then applied on a surface of a positive electrode current collector using a doctor blade, followed by drying, whereby a positive electrode active material layer is formed on the surface of the positive electrode current collector to obtain a positive electrode.

(2) A negative electrode active material constituting a negative electrode active material layer is dispersed in a solvent to obtain a negative electrode layer slurry. The solvent used in this case is not particularly limited, and water and various organic solvents can be used. The negative electrode layer slurry is then applied on a surface of a negative electrode current collector using a doctor blade, followed by drying, whereby a negative electrode active material layer is formed on the surface of the negative electrode current collector to obtain a negative electrode. Alternatively, a sheet or foil of a metal active material may be used as the negative electrode active material layer.

(3) Layers are laminated so that an electrolyte layer (solid electrolyte layer or separator) is interposed between the negative electrode and the positive electrode to obtain a laminated body comprising a negative electrode current collector, a negative electrode active material layer, an electrolyte layer, a positive electrode active material layer, and a positive electrode current collector in this order. Additional members such as terminals are attached to the laminated body as needed.

(4) The laminated body is housed in a battery case. In the case of an electrolytic solution battery, the battery case is filled with an electrolytic solution. The laminated body is immersed in the electrolytic solution and sealed in the battery case, whereby a secondary battery is obtained. In the case of an electrolytic solution battery, the electrolytic solution may be incorporated into the negative electrode active material layer, the separator, and the positive electrode active material layer in the above step (3).

### EXAMPLES

From the foregoing, one embodiment of the positive electrode active material for sodium-ion batteries has been described. However, the technique of the present disclosure can be modified in various ways other than the above embodiments in ranges that do not depart from the spirit of the invention. Hereinafter, the technique of the present disclosure will be further described with reference to the Examples. However, the technique of the present disclosure is not limited to the following Examples.

### 1. Manufacture of Positive Electrode Active Material

### 1.1 Example 1-1

Na₂O and NaFeO₂ were mixed in a stoichiometric ratio so as to obtain a chemical composition of Na₄FeO_{3.5}, and 0.4 g of a mixture (powder) was obtained. The mixture and 10 g of 3-mmo zirconia balls were placed in a 45-mL zirconia pot, which was then sealed. The sealed zirconia pot was mounted to a planetary ball mill apparatus (PL-7, manufactured by Fritsch GmbH) and subjected to a mechanical milling process at a rotation speed of 600 rpm for 50 h to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 1.2 Example 1-2

Na₂O and NaFeO₂ were mixed in a stoichiometric ratio so as to obtain a chemical composition of Na₅FeO₄, and 0.4 g of a mixture (powder) was obtained. The mixture was subjected to a mechanical milling process under the same conditions as in Example 1-1 to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 1.3 Example 1-3

Na₂O and NaFeO₂ were mixed in a stoichiometric ratio so as to obtain a chemical composition of Na₅FeO₄, and 0.4 g of a mixture (powder) was obtained. The mixture was molded to obtain a pellet. The pellet was placed in a crucible made of carbon and fired in an Ar atmosphere at 600° C. for 20 h to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 1.4 Comparative Example 1-1

Na₂O and NaFeO₂ were mixed in a stoichiometric ratio so as to obtain a chemical composition of Na₃FeO₃, and 0.4 g of a mixture (powder) was obtained. The mixture was subjected to a mechanical milling process under the same conditions as in Example 1-1 to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 1.5 Comparative Example 1-2

Na₂O and NaFeO₂ were mixed in a stoichiometric ratio so as to obtain a chemical composition of Na₉FeO₆, and 0.4 g of a mixture (powder) was obtained. The mixture was subjected to a mechanical milling process under the same conditions as in Example 1-1 to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 1.6 Example 2-1

Na₂O, NaFeO₂, and NaMnO₂ were mixed in a stoichiometric ratio so as to obtain a chemical composition of Na₅Fe_{0.75}Mn_{0.25}O₄, and 0.4 g of a mixture (powder) was obtained. The mixture was subjected to a mechanical milling process under the same conditions as in Example 1-1 to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 1.7 Example 2-2

Na₂O, NaFeO₂, and NaMnO₂ were mixed in a stoichiometric ratio so as to obtain a chemical composition of Na₅Fe_{0.5}Mn_{0.5}O₄, and 0.4 g of a mixture (powder) was obtained. The mixture was subjected to a mechanical milling process under the same conditions as in Example 1-1 to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 1.8 Comparative Example 2-1

Na₂O and NaMnO₂ were mixed in a stoichiometric ratio so as to obtain a chemical composition of Na₅MnO4, and 0.4 g of a mixture (powder) was obtained. The mixture was subjected to a mechanical milling process under the same conditions as in Example 1-1 to obtain a Na-containing composite oxide as a positive electrode active material. The chemical composition of the Na-containing composite oxide was unchanged from that prior to the mechanical milling process. The crystal structure of the Na-containing composite oxide was confirmed by X-ray diffraction measurement, and the crystal structure belonged to the space group Pn21a.

### 2. Manufacture of Positive Electrode

The positive electrode active material described above and a carbon-based conductive aid were weighed so as to obtain a mass ratio of positive electrode active material: conductive aid=75:25. The weighed positive electrode active material and conductive aid and 10 g of 0.8-mmo zirconia balls were placed in a 45-mL zirconia pot, which was then sealed. The sealed zirconia pot was mounted to a planetary ball mill apparatus (PL-7, manufactured by Fritsch GmbH) and subjected to a mixing process at a rotation speed of 300 rpm for 30 h to obtain a positive electrode mixture. The chemical composition and crystal structure of the positive electrode active material contained in the positive electrode mixture after the mixing process were substantially the same as the chemical composition and crystal structure prior to the mixing process. The obtained positive electrode mixture was kneaded with PTFE and then pressed onto an Al mesh to obtain a positive electrode.

### 3. Manufacture and Evaluation of Battery

The positive electrode described above, a sodium metal negative electrode, an electrolytic solution (electrolyte: 1 M NaPF₆, solvent: PC), and a glass-fiber separator were used to produce a battery for evaluation. The obtained battery was charged and discharged under a constant-current mode at a current density of 10 mA/g. The initial discharge capacity and average voltage were measured.

### 4. Evaluation Results

Table 1 below shows the manufacturing condition and chemical composition of each positive electrode active material and the discharge capacity and average voltage of each battery.

TABLE 1

| | Manufac- | | Discharge | Average |
|---|---|---|---|---|
| | turing | Chemical | capacity | voltage |
| | condition | composition | (mAh/g) | (V) |
| Example 1-1 | Mechanical | Na₄FeO_{3.5} | 195.3 | 2.443 |
| | milling | | | |
| Example 1-2 | Mechanical | Na₅FeO₄ | 200.0 | 2.253 |
| | milling | | | |
| Example 1-3 | Firing | Na₅FeO₄ | 154.0 | Not |
| | | | | measured |
| Comparative | Mechanical | Na₃FeO₃ | 81.0 | 2.778 |
| Example 1-1 | milling | | | |
| Comparative | Mechanical | Na₉FeO₆ | 26.7 | 2.126 |
| Example 1-2 | milling | | | |
| Example 2-1 | Mechanical | Na₅Fe_{0.75}Mn_{0.25}O₄ | 242.5 | 2.194 |
| | milling | | | |
| Example 2-2 | Mechanical | Na₅Fe_{0.5}Mn_{0.5}O₄ | 300.4 | 2.646 |
| | milling | | | |
| Comparative | Mechanical | Na₅MnO₄ | 66.6 | 2.630 |
| Example 2-1 | milling | | | |

As is clear from the results shown in Table 1, a Na-containing composite oxide satisfying the following requirements (A) and (B), as a positive electrode active material for sodium-ion batteries, can be said to have high capacity.

(A) The Na-containing composite oxide has the chemical composition indicated below.

$${Na}_{x} {Fe}_{y} {M}_{1 - y} {O}_{z}$$

$$3. < x < 9.$$

$$0 < y \leq 1.$$

$$3. < z < 6.$$

M: one or more selected from Mn, P, Cr, Sc, Ti, V, Cr, Co, Ni, Cu, Zn, and Ga (B) The Na-containing composite oxide has a crystal structure belonging to space group Pn21a.

In the above Examples, the case in which an element M constituting the Na-containing composite oxide is not contained or the case in which Mn is adopted as the element M was exemplified. However, the element M is not limited thereto. It is considered that when the element M is one or more selected from Mn, P, Cr, Sc, Ti, V, Cr, Co, Ni, Cu, Zn, and Ga, high capacity is ensured as a positive electrode active material.

### REFERENCE SIGNS LIST

100 battery
10 positive electrode active material layer
20 electrolyte layer
30 negative electrode active material layer
40 positive electrode current collector
50 negative electrode current collector

1. A positive electrode active material for sodium-ion batteries, comprising a Na-containing composite oxide, wherein
the Na-containing composite oxide has a chemical composition represented by
$${Na}_{x} {Fe}_{y} {M}_{1 - y} {O}_{z}$$
$$3. < x < 9. ;$$
$$0 < y \leq 1. ;$$
$$3. < z < 6. ;$$
and
M: one or more selected from Mn, P, Cr, Sc, Ti, V, Cr, Co, Ni, Cu, Zn, and Ga, and the Na-containing composite oxide has a crystal structure belonging to space group Pn21a.

2. The positive electrode active material for sodium-ion batteries according to claim 1, wherein
the Na-containing composite oxide has a chemical composition represented by
$${Na}_{x} {Fe}_{y} {M}_{1 - y} {O}_{z}$$
$$3. < x < 6. ;$$
$$0.5 < y \leq 1. ; and$$
$$3. < z < 4.5 .$$

3. A method of manufacturing a positive electrode active material for sodium-ion batteries, the method comprising
obtaining a mixture comprising a Na-containing oxide and a Fe-containing oxide, and
applying an energy to the mixture to obtain a Na-containing composite oxide, wherein
a ratio of the Na-containing oxide to the Fe-containing oxide in the mixture is adjusted so that the Na-containing composite oxide has a chemical composition represented by
$${Na}_{x} {Fe}_{y} {M}_{1 - y} {O}_{z}$$
$$3. < x < 9. ;$$
$$0 < y \leq 1. ;$$
$$3. < z < 6. ;$$
and
M: one or more selected from Mn, P, Cr, Sc, Ti, V, Cr, Co, Ni, Cu, Zn, and Ga, and
the energy applied to the mixture is adjusted so that the Na-containing composite oxide has a crystal structure belonging to space group Pn21a.

4. The method of manufacturing a positive electrode active material for sodium-ion batteries according to claim 3, the method comprising
applying mechanical energy to the mixture by mechanical milling to obtain the Na-containing composite oxide, wherein
firing of the Na-containing composite oxide is not carried out after the mechanical milling.

5. A sodium-ion battery, comprising a positive electrode active material layer, an electrolyte layer, and a negative electrode active material layer, wherein
the positive electrode active material layer comprises the positive electrode active material for sodium-ion batteries according to claim 1.
